(19) United States
(12) Patent Application Publication
(10) Pub. No.: US 2018/0325052 A1
(43) Pub. Date: Nov. 15, 2018

(54) AEROPONIC INSTALLATION, SYSTEM AND FREIGHT CONTAINER

(71) Applicant: AGRICOOL, La Courneuve (FR)

(72) Inventors: Gonzague GRU, Estrees Mons (FR); Paul Hector OLIVER, Paris (FR); Guillaume ROSSI, Le Perreux Sur Marne (FR); Pierre JAY, Paris (FR)

(21) Appl. No.: 15/974,726

(22) Filed: May 9, 2018

(30) Foreign Application Priority Data
May 9, 2017 (FR) 17 54035

(51) Int. Cl. A01G 31/02; A01G 7/04; A01G 9/02; A01G 29/00

(52) U.S. Cl. CPC A01G 31/02; A01G 29/00; A01G 9/023; A01G 7/045

(57) ABSTRACT

An aeroponic plant growth installation includes: a vertical support including a side capable of defining an inside of the vertical support extending from an upper end to a lower end of the vertical support, the at least one side including receiving openings each adapted to receive a cultivation container; a plurality of cultivation containers each including: a wall having a cross section defining an interior space, and first and second ends open, the cultivation containers being capable of being received in a receiving opening such that the second end of the cultivation container is inside the vertical support, and a material which is deformable so as to allow the growth of a plant, the material being disposed in the interior space of the cultivation containers; and a misting system capable of spraying a nutrient liquid onto the roots of the plant at the upper end of the vertical support.

The invention relates to the technical field of the aeroponic cultivation of plants, in particular aeroponic plant growth plants.

More specifically, the invention relates to the field of aeroponic plant growth plants, systems comprising an aeroponic facility and freight containers comprising such facilities.

Nowadays, aeroponic cultivation of plants is booming. The aeroponic cultivation of plants is one of the highly successful recent methods used in the indoor or outdoor plant cultivation. In aeroponics, the plant growth is performed off-ground. The support function and the water and nutriments supply function, normally carried out by the soil, are provided by plant supports, for example towers, and by nutrient solution spraying or permanent jets in a closed circuit.

In particular, document WO2017/058116 is known which describes an aeroponic installation comprising a vertical tower along which openings are arranged so as to receive baskets. Each basket is lined with foam in which a seed is planted that will grow into a plant. The baskets comprise multiple openings allowing the roots to grow and the nutrient solution to enter and exit the basket. The nutrient solution is delivered “drop by drop” by a shower located at the upper end of the vertical tower.

However, the “drop by drop” nutrient solution delivery by a shower does not allow a homogeneous contact of the plant roots with the nutrient solution. In addition, the nutrient solution must first pass through the openings of the baskets to get in contact with the roots.

The present invention aims to improve the situation.

For this purpose, the subject of the invention is an aeroponic plant growth installation comprising
at least one vertical support comprising at least one side capable of defining an interior of the vertical support extending from an upper end to a lower end of the vertical support, in which the at least one side comprises a plurality of suitable receiving openings each to receive a cultivation container,
a plurality of cultivation containers each comprising:
   a wall having a cross section which defines an interior space, and a first and a second open ends, said cultivation containers being receivable in a receiving opening so that the second end of the cultivation container is in the inside of the vertical support,
   a deformable material for allowing the growth of a plant, said material being disposed in the interior space of the cultivation containers, and
a misting system capable of spraying a nutrient liquid onto the roots of the plant at the upper end of the vertical support.

Thanks to these arrangements, the roots of the plants are directly in contact with the nutrient solution which is delivered homogeneously to all the roots of the plants included in the installation.

In one embodiment, the wall of the cultivation container comprises a cross section at the first end of larger size than a cross section at the second end of the cultivation container.

According to one embodiment, the receiving opening comprises a section of polygonal shape comprising as many sides as the cross-section of the wall of the cultivation container, said section of the receiving opening being smaller in size than the first end of the cultivation container, and larger in size than the second end of the cultivation container.

According to one embodiment, the cultivation container is capable of being received obliquely in the receiving opening, so that the first open end of the cultivation container is oriented upwards when said cultivation container is received in the receiving opening.

According to one embodiment, the installation further comprises a collection system to collect the nutrient liquid, disposed at the lower end of the vertical support.

In one embodiment, the misting system is capable of delivering the nutrient liquid in the form of a mist.

According to one embodiment, the installation further comprises a light system capable of illuminating the first end of the cultivation containers.

According to one embodiment, the cultivation container comprises an abutment which is resiliently deformable at its first end, said abutment being capable of bearing against an inside of said side of the vertical support, so that the cultivation container is held in the reception opening.

In one embodiment, the receiving openings have a non-revolution geometry.

In one embodiment, the cross section has a polygonal shape.

In one embodiment, the material is an inert plastic foam.

In one embodiment, the receiving openings are spaced transversely on the side of the vertical support.

The present invention also provides a vertical support comprising at least one side capable of defining an inside extending from an upper end to a lower end of the vertical support, said at least one side comprising a plurality of receiving openings, said vertical support further comprising an intake allowing misting of the inside at the upper end of said vertical support.

The present invention also provides a system comprising an installation according to the invention, wherein the plurality of cultivation containers is a first plurality of cultivation containers, said system further comprising a second plurality of cultivation containers of different dimensions from the first plurality of cultivation containers and receivable in said receiving openings.

The present invention also relates to a container comprising an installation according to the invention.

The figures of the drawings are now briefly described.

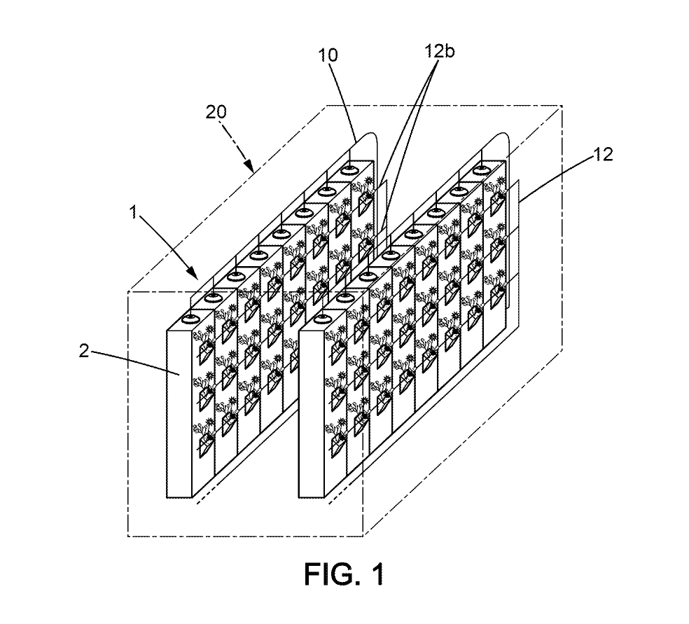

FIG. 1 illustrates a freight container comprising an aeroponic installation according to the invention.

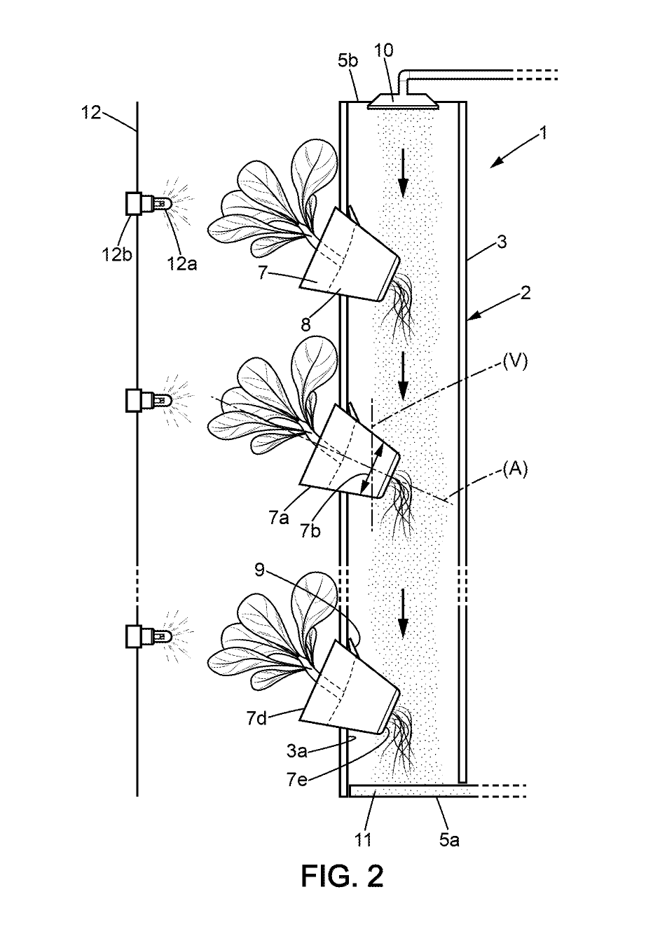

FIG. 2 is a sectional view of the aeroponic installation according to one embodiment of the invention.

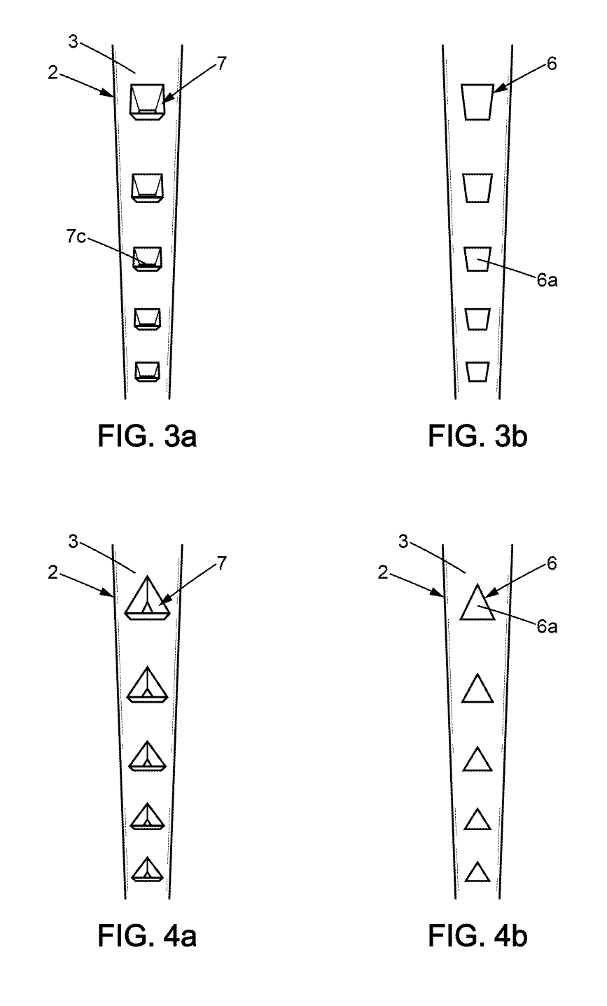

FIG. 3a illustrates a vertical support comprising cultivation containers according to one embodiment of the invention.

FIG. 3b illustrates the receiving openings of a vertical support capable of receiving cultivation containers according to the embodiment illustrated in FIG. 2a.

FIG. 4a illustrates a vertical support comprising cultivation containers according to another embodiment of the invention,

FIG. 4b illustrates the receiving openings of a vertical support capable of receiving cultivation containers according to the embodiment illustrated in FIG. 3a,

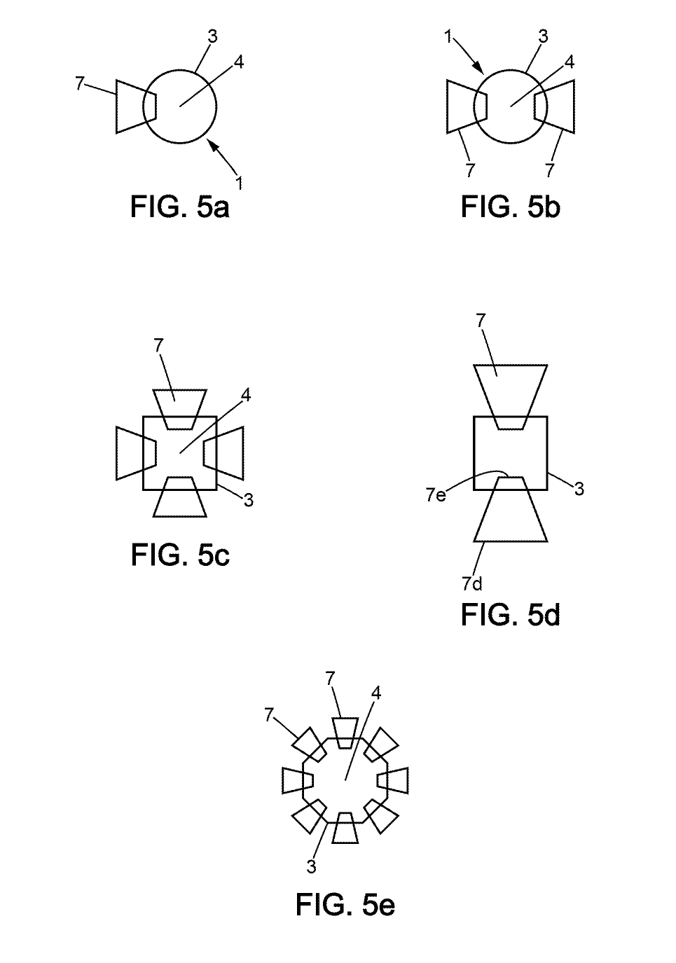

FIGS. 5a to 5e are top views of a vertical support according to various embodiments,

Hereinafter comes a detailed description of several embodiments of the invention together with examples and references to the drawings.

FIG. 1 illustrates a freight container 20 comprising an aeroponic installation 1 for growing plants according to the invention. The aeroponic installation 1 comprises a plurality of vertical supports 2, a misting system 10 capable of feeding the plants, and a light system 12.

Of course, the number of plants shown in FIG. 1 is there by way of non-limiting example.

In the following description, “vertical support” means a support strictly oriented in the vertical direction, parallel to the direction of gravity, or inclined at an angle of about 5° with the vertical.

With reference to FIG. 2, an aeroponic installation 1 for growing plants according to one embodiment of the invention is described. Each vertical support 2 comprises at least one side 3 defining an inside 4 of the vertical support 2. The inside 4 of the vertical support 2 extends longitudinally from a lower end 5a to an upper end 5b of the vertical support 2.

The vertical supports 2 have for example a circular closed cross section when they comprise a single side 3. In the case in which the vertical supports 2 comprise more than one side, more precisely more than two sides, they have a closed polygonal cross section. For example, if the cross section of the vertical supports 2 has a triangular shape, the vertical supports 2 then comprise three sides. The vertical supports 2 may have as many sides 3 as possible. The cross section of the vertical supports 2 may for example be triangular, quadrilateral, square, rectangular, hexagonal, etc. The shape of the cross sections is defined by the number of sides 3 defining the inside 4 of the vertical supports 2.

In the following part of the description, it is considered that the vertical supports 2 have a polygonal cross section. Of course, the examples and embodiments described hereinafter also apply to the embodiment in which the vertical supports 2 comprise only one side 3, and therefore have a circular cross section.

The lower ends 5a and 5b are for example covered, so that the vertical supports 2 are completely closed. Alternatively, only one or the other of the ends 5a, 5b may be covered, or none of them.

The plurality of vertical supports 2 has receiving openings 6 adapted to receive cultivation containers 7 in which the plants are intended to grow. The receiving openings 6 are, for example, cutouts made on one of the sides 3 of the vertical supports 2.

The receiving openings 6 may be spaced longitudinally along a side 3 of the vertical supports 2, transversely on the same side 3 of the vertical supports 2, or both.

Both longitudinal and cross dimensions of the sides 3 of the vertical supports 2 may vary according to the receiving openings 6 layout and number.

In the non-limiting embodiment shown in FIG. 2, the receiving openings 6 are provided along the same side 3 of the vertical support 2. The receiving openings 6 have for example a polygonal shape which comprises at least three sides. The shape of the receiving openings 6 makes it possible, for example, to insert the cultivation containers 7 therein.

The cultivation containers 7 comprise for example a wall 7a having a cross section 7b. The cross section 7b may be of circular shape, and then only comprises one side, or of polygonal shape, comprising several sides, in particular more than two sides. The wall 7a defines an interior space 7c and a first and a second ends 7d, 7e. The first and second ends 7d, 7e may be open.

The receiving openings 6 comprise for example the same number of sides as the cross section 7b of the cultivation containers 7.

In the following description, it is considered that the cultivation containers 7 have a cross section 7b of polygonal shape. Of course, the examples and embodiments described hereinafter also apply to the embodiment in which the cultivation containers 7 have a circular cross section 7b.

In one embodiment, the cross-section 7b at the second end 7e is, for example, smaller than the cross-section 7b at the first end 7d of the cultivation container 7, so that the cultivation containers 7 generally have a form of truncated cone and, in the case where there are four sides, truncated pyramid.

An axis A can then be defined, which is perpendicular to the cross section 7b of the cultivation containers 7 and passing in its center.

The cultivation containers 7 are for example received obliquely in the receiving openings 6, so that part of the cultivation containers 7, especially at the first end 7d, protrudes outside the vertical supports 2, while the other part of the cultivation containers 7 is disposed inside the vertical supports 2, and so that the first end 7d is oriented upwards. The axis A of the cultivation containers 7 and a vertical direction V parallel to the direction of gravity, then form an angle between 0° and 90°. The value of the angle is in particular determined according to the type of plant to be grown in the cultivation container 7.

To allow this arrangement, it can then be provided that the receiving openings 6 have a smaller section 6a than the largest cross section 7b of the cultivation containers 7.

For example, in the non-limiting embodiment shown in FIGS. 3a and 3b, the cultivation containers 7 have a square cross section 7b that corresponds to a four-sided polygon. The receiving openings 6 also include four sides.

The receiving openings 6 then have a side which has a slightly smaller dimension than one of the sides of the first end 7d of the cultivation container 7 and a side which has a greater dimension than one of the sides of the second end 7e of the cultivation container. 7, so that the receiving opening 6 is of generally trapezoidal shape. This geometry makes it in particular possible to keep the cultivation containers 7 obliquely in the receiving openings 6.

The shorter side is for example the side facing the lower end 5a of the vertical support, and the longer side is for example the side facing the upper end 5b of the vertical support 2.

This geometry is applicable whatever the shape and number of sides of the cross section 7b of the cultivation container 7.

For example, as illustrated in FIGS. 4a and 4b, the cultivation containers 7 may have a triangular cross section 7b. The first end 7d of the cultivation container 7 always comprises a cross section 7b greater than the cross section 7b at the second end 7e.

In this case, it can be provided that the receiving openings 6 are also of triangular shape. The receiving openings 6 are for example oriented such that an angle of the receiving opening 6 is oriented towards the upper end 5b of the vertical support 2.

To allow the cultivation containers 7 to be held in the receiving openings 6, provision is made, for example, to slightly reduce the size of the angle oriented towards the upper end 5b, and to reduce the base length of the receiving opening 6.

In this way, the first end 7d of the cultivation containers 7 is oriented upwards, and the cultivation containers 7 are received obliquely in the receiving openings 6.

These illustrative examples are not meant to be restrictive. For example, there may be cultivation containers 7 having a cross section 7b which comprises more than four sides.

The cultivation containers 7 may further be provided with an abutment 9 which is elastically deformable at the first end 7d. The abutment 9 extends for example transversely to the wall 7a of the cultivation container 7. The abutment 9 is for example intended to bear against an inside 3a of a side 3 so as to prevent the cultivation container 7 to tumble from the receiving opening 6.

Should a user wish to remove a cultivation container 7 from a receiving opening 6, it is sufficient to pull the cultivation container 7 outwards. The force exerted by the user causes the abutment 9 to deform, thus making it possible to release the cultivation container 7.

In a variant, it is possible to provide an abutment 9 made of a material with little elastic deformability and a vertical support 2 made of an elastically deformable material, at least in a zone around the receiving openings 6. In this way, when the user inserts or withdraws a cultivation container 7 from a receiving opening 6, it is the side 3 of the vertical support 2 comprising the receiving opening 6 which is elastically deformed. In this way, the abutment 9 is less likely to be altered in the long run by repeated elastic deformations.

The interior space 7c of the cultivation containers 7 may be filled with a material 8 used to hold the plant in the cultivation container 7. The material 8 is inserted into the wall 7a so that it does not protrude outside the wall 7a of the cultivation container 7. The material 8 is not intended to guide the nutrient liquid on the root system of the plant. The material 8 is, for example, polymeric foam suitable for growing plants, for example inert plastic foam.

Seedlings are, for example, inserted into the material 8. This allows, among other things, to select the plants that are best able to grow and be productive when they mature.

Alternatively, a seed can be planted in the material 8, so that all of the plant growth is performed in a cultivation container 7.

The material 8 is inserted into the cultivation containers 7 so that the root system of the plant develops at the second end 7e of the cultivation containers 7 and the stem system of the plant develops at the first end 7d. Thus, when the cultivation containers 7 are inserted into the vertical supports 2, the root system of the plants is located in the inside 4 of the vertical supports 2, and the stem system of the plants is outside the vertical supports 2. The plant is maintained in the cultivation container 7 by compressing the material 8 at an intermediate region between the root system of the plants and the stem system of the plants.

The size of the cultivation containers 7 may vary depending on the types of plants. For example, the cross section 7b at the first end 7d may be larger or smaller. For example, if the plant foliage density is large, a cross section 7b at the first end will be greater than for a plant growing little foliage.

On the other hand, the shape of the cultivation containers 7 and the receiving openings 6 makes it possible to prevent the cultivation containers 7 from moving when they are inserted in the vertical support 2, for example a rotation, which can lead to the fall of the cultivation containers 7 or the alteration of the plants. Preferably, the receiving opening 6 is not rotationally symmetrical.

The receiving openings 6 may be designed capable of receiving cultivation containers 7 of different sizes, so that several kinds of plants can be cultivated without modifying the vertical supports 2.

In order to allow the plants to grow, the installation 1 also comprises a misting system 10. The misting system 10 is for example able to project a nutrient liquid onto the root system of the plants in the form of a mist. The mist is composed of nutrient liquid droplets the size of which is for example comprised between 10 μm and 30 μm. The nutrient liquid is for example composed of water and nutrients adapted to the growth of the plants. A misting system 10 is for example provided for each vertical support 2.

The misting system 10 may comprise a nozzle located at the upper end 5b of each vertical support 2, so that the nutrient liquid is delivered into the inside 4 of each vertical support 2.

Alternatively, it can be provided that, for the same vertical support 2, more than one nozzle is used to deliver the nutrient liquid into the inside 4 of the vertical support 2, to better homogenize the diffusion of the nutrient liquid.

The nutrient liquid travels the inside 4 of the vertical support 2 from the upper end 5b to the lower end 5a under the effect of gravity so as to come into contact with the root system of all the plants arranged in the cultivation containers 7 carried by the vertical support 2. The nutrient liquid is in particular guided by the sides 3 of the vertical support 2 and remains confined in the inside 4.

The misting system 10 further comprises a nutrient liquid collection system 11 located at the lower end 5a of each vertical support 2. The collection system 11 is for example capable of transporting the used nutrient liquid to an analysis chamber (not shown) to determine if the nutrient liquid can be sprayed again onto the plants or if treatment thereof is needed. In the latter case, the nutrient liquid can be treated in the analysis chamber, for example by enriching the nutrient liquid with nutrients.

The installation 1 may also comprise a light system 12. The light system 12 is for example disposed outside of a vertical support 2, facing the cultivation containers 7, so that it illuminates the stem system of the plants. The light system 12 comprises for example low consumption light-emitting diodes 12a (or “LED”). The light system 12 is for example composed of a plurality of light tubes 12b which include the LEDs 12a. The light tubes 12b are for example oriented horizontally, so that each light tube 12b illuminates a plurality of vertical supports 2. For example, it is provided that the LEDs 12a of the light tubes 12b are arranged facing the cultivation containers 7 when they are inserted in the vertical supports 2.

For example, a light system 12 may comprise enough light tubes 12b to illuminate all the cultivation containers 7 on a side 3 of a vertical support 2. It can further be provided that several light systems 12 are necessary to illuminate the cultivation containers 7 of a complete side 3 of a vertical support 2.

The light systems are for example removably mounted on a structure (not shown) included in the container 20.

A light system 12 can be provided for each vertical support 2.

The light system 12 and the misting system 10 can be configured according to the types of plants so that the growth and the growth cycle of the plants are respected.

The plants are further protected by the wall 7a of the cultivation containers 7 which prevent the plant parts which do not tolerate being in contact with the nutrient liquid are exposed.

FIGS. 5a to 5b illustrate alternative embodiments of the vertical supports 2.

As described above, and with reference to FIGS. 5a and 5b, the vertical supports 2 may for example comprise a side 3, defining an inside 4 having a circular cross section.

In FIG. 5a, cultivation containers 7 are spaced longitudinally along the side 3. As viewed from above, a single cultivation container 7 is visible but it is understood that others may be in alignment with it.

In FIG. 5b, two longitudinal rows of cultivation containers 7 face each other. Thus, it is possible to further optimize the use of the vertical supports 2 by integrating more than one row of cultivation containers 7 on the same support 2.

In FIGS. 5c and 5d, a vertical support 2 having a square cross section has been illustrated.

In FIG. 5c, each of the sides 3 of the vertical support 2 comprises cultivation containers 7.

The size of the cultivation containers 7 and of the vertical support 2 are adapted to the number of sides comprising cultivation containers 7 so that the root systems of the plants do not intermingle during the growth of the plants. Thus, when the plants reach maturity, it is always easy to remove the cultivation containers 7 from the vertical support 2 without tearing the roots.

In FIG. 5d, there is shown a vertical support 2 whose two sides 3 comprise cultivation containers 7. The cultivation containers 7 have cross sections 7b at their first end 7d much wider than those of the cultivation containers 7 shown in FIGS. 4a to 4c. This type of cultivation container 7 is especially suitable for the growth of very leafy plants, for example rhubarb or cabbage.

If the installation is used for the growth of bulky plants, especially rhubarb or cabbage which are very leafy and dense, only one vertical support 2 out of two may be used, so as not to impede the growth of the plants. In this case, the misting system 10 specific to the vertical support 2 not used can be switched off so as not to spoil nutrient liquid.

In FIG. 5e, there is shown a vertical support 2 the cross section of which comprises eight sides. This type of geometry makes it in particular possible to insert a very large number of cultivation containers 7.

The examples described above are given for illustrative purposes only.

An example of a process for the growth of a plant in the installation 1 is described below.

First, a young plant is provided that is inserted into the material 8. The material 8 is then incorporated into a cultivation container 7 so that the root system of the plant faces the second end 7e of the cultivation container 7 and the stem system faces the first end 7d.

The material 8 is for example deformable and compressible. The material 8 and the plant are maintained in the cultivation container 7 by compressing the material 8 in the wall of the cultivation container 7. The compression zone is for example located between the root system and the stem system of the plant.

Then, the cultivation container 7 is inserted into a receiving opening 6. During the insertion, the abutment 9 deforms elastically and then returns to its original shape once inserted into the receiving opening 6, so that the abutment 9 bears on the inside 3a of the side 3 comprising the reception opening 6. The abutment 9 allows in particular to prevent the cultivation container 7 tumbling out of the receiving opening 6, for example as caused by the weight of the plant.

The nutrient liquid dispensed by the misting system 10 on the root system of the plant, and the light system 12 which illuminates the stem system of the plant, allow the plant to grow.

Regularly, the products resulting from the plant growth are harvested. For example, the plant will produce fruits, flowers, leaves or stems.

When the plant no longer produces, the cultivation container 7 is removed by pulling it out of the receiving opening 6. This will cause the abutment 9 to elastically deform so as to allow the cultivation container to be removed. The plant can then be removed from the material 8 for recycling, and a younger plant can be inserted into the material 8. The steps described above are then reproduced.

Alternatively, the material 8 and the young plant may be inserted into the cultivation container 7 only once the cultivation container 7 has already been inserted into the receiving opening 6. Similarly, it is possible to remove the material 8 and the plant to be recycled, leaving the cultivation container 7 in the receiving opening 6.

Of course, the present invention is not limited to the embodiments described above by way of example; it extends to further alternative embodiments.

For example, the installation 1 can be placed outside, so that a light system 12 as described above is no longer necessary.

References:

Installation 1
vertical support 2
side 3
inside of side 3a
inside 4
lower end 5a
upper end 5b
hosting opening 6
section 6a
cultivation container 7
wall 7a
cross section 7b
interior space 7c
first end 7d
second end 7e
material
abutment 9
misting system 10
collection system 11
light system 12
LED 12a
light tube 12b

1. An aeroponic plant growth installation comprising
at least one vertical support comprising at least one side capable of defining an inside of the vertical support extending from an upper end to a lower end of the vertical support, wherein said at least one side comprises a plurality of receiving openings each adapted to receive a cultivation container,
a plurality of cultivation containers each comprising:
a wall having a cross section defining an interior space, and first and second ends open, said cultivation containers being capable of being received in a receiving opening such that the second end of the cultivation container is inside the vertical support,
a material which is deformable so as to allow the growth of a plant, said material being disposed in the interior space of the cultivation containers, and
a misting system capable of spraying a nutrient liquid onto the roots of the plant at the upper end of the vertical support.

2. The installation according to claim 1, wherein the wall of the cultivation container comprises a cross section at the first end larger than a cross section at level of the second end of the cultivation container.

3. The installation according to claim 1, wherein the receiving opening comprises a section of polygonal shape comprising as many sides as the cross section of the wall of the cultivation container, said section of the receiving opening being smaller in size than the first end of the cultivation container, and of larger size than the second end of the cultivation container.

4. The installation according to claim 1, wherein the cultivation container is capable of being received obliquely in the receiving opening, so that the first end open of the cultivation container is oriented upwards when said cultivation container is received in the receiving opening.

5. The installation according to claim 1, further comprising a collection system to collect the nutrient liquid, disposed at the lower end of the vertical support.

6. The installation according to claim 5, wherein the misting system is adapted to deliver the nutrient liquid in the form of a mist.

7. The installation according to claim 1, further comprising a light system capable of illuminating the first end of the cultivation containers.

8. The installation according to claim 1, wherein the cultivation container comprises an abutment which is resiliently deformable at its first end, said abutment being capable of bearing against an inside of said side of the vertical support, so that the cultivation container is held in the receiving opening.

9. The installation according to claim 1, wherein the receiving openings have a non-revolution geometry.

10. The installation according to claim 1, wherein the cross section has a polygonal shape.

11. The installation according to claim 1, wherein the material is an inert plastic foam.

12. The installation according to claim 1, wherein the receiving openings are spaced longitudinally along the side of the vertical support.

13. The installation according to claim 1, wherein the receiving openings are spaced transversely on the side of the vertical support.

14. A vertical support characterized in that it comprises at least one side capable of defining an inside extending from an upper end to a lower end of the vertical support, said at least one side comprising a plurality of receiving openings, said vertical support further comprising an intake allowing misting of the inside at the upper end of said vertical support.

15. A system characterized in that it comprises an installation according to claim 1, wherein the plurality of cultivation containers is a first plurality of cultivation containers, said system further comprising a second plurality of cultivation containers of different dimensions from the first plurality of cultivation containers and receivable in said receiving openings.

16. A freight container characterized in that it comprises an installation according to claim 1.
